(19) United States
(12) Patent Application Publication
(10) Pub. No.: US 2026/0057795 A1
(43) Pub. Date: Feb. 26, 2026

(54) SYSTEM

(71) Applicant: SoftBank Group Corp., Tokyo (JP)

(72) Inventor: Mamoru SUZUKI, Tokyo (JP)

(21) Appl. No.: 19/297,277

(22) Filed: Aug. 12, 2025

(30) Foreign Application Priority Data
Aug. 23, 2024 (JP) 2024-142377

(51) Int. Cl. G09B 5/06; G06F 3/16; G06V 40/16

(52) U.S. Cl. CPC G09B 5/06; G06F 3/167; G06V 40/174

(57) ABSTRACT

The system according to the embodiment comprises an input unit, a monitoring unit, and a providing unit. The input unit allows the guardian to input information about the child. The monitoring unit monitors the state of the child based on the information input via the input unit. The providing unit provides content based on the information monitored by the monitoring unit.

### CROSS-REFERENCE TO RELATED APPLICATION

The present application claims priority to and incorporates by reference the entire contents of Japanese Patent Application No. 2024-142377 filed in Japan on Aug. 23, 2024.

### BACKGROUND OF THE INVENTION

### Field of the Invention

The technology of this disclosure relates to a system.

### Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, it has been difficult to provide content tailored to the child's interests and level of concentration, and there has been a problem in that education is not conducted in accordance with the guardian's intentions.

### SUMMARY OF THE INVENTION

The system according to the embodiment comprises an input unit, a monitoring unit, and a providing unit. The input unit allows the guardian to input information about the child. The monitoring unit monitors the state of the child based on the information input via the input unit. The providing unit provides content based on the information monitored by the monitoring unit.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

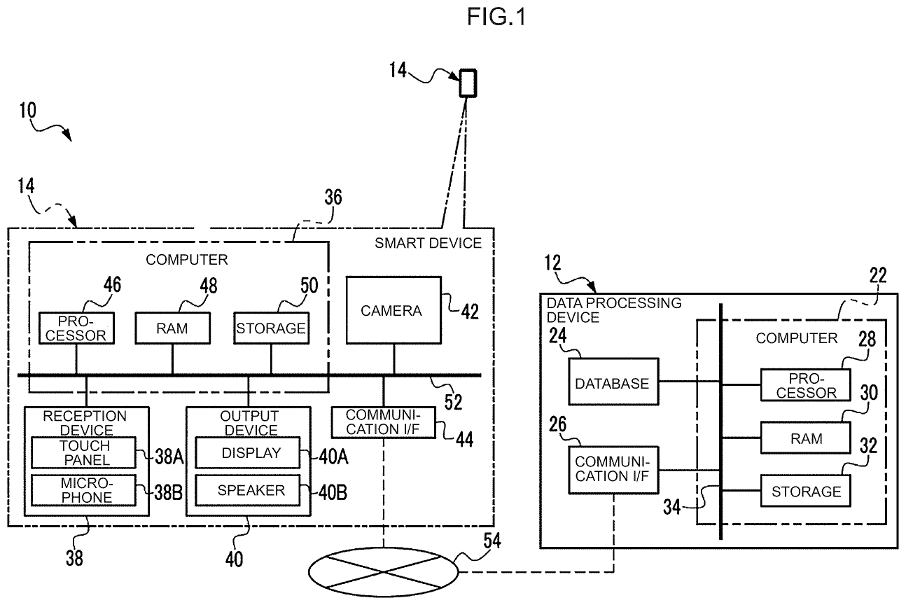

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

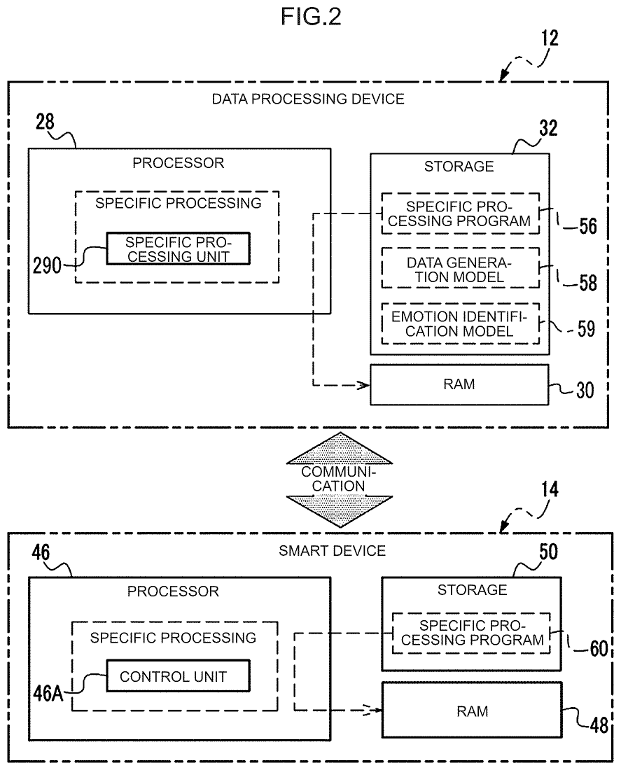

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The system according to the embodiment of the present invention is a system in which a guardian pre-sets information about the child, the content to be provided, and the time, analyzes the child's level of concentration and interest using a camera, and AI provides content that matches the guardian's intentions and the child's interests. The system allows the guardian to pre-set information about the child, the content to be provided, and the time, analyzes the child's level of concentration and interest using a camera, and AI provides content that matches the guardian's intentions and the child's interests. For example, if the child becomes bored with learning, play content can be provided. In addition, the system provides a report of the learning results to the guardian and aims to generate revenue by proposing teaching materials and services suited to the child's characteristics and the guardian's needs. For example, the guardian pre-sets information about the child, the content to be provided, and the time. At this time, information such as the child's age, interests, and learning goals is input. For example, the guardian sets “I want to provide 30 minutes of English learning content to a 5-year-old child.” This information is input to the AI. Next, the child's level of concentration and interest is analyzed using a camera. The camera monitors the child's facial expressions and movements in real time, and the AI analyzes them. For example, it can determine whether the child is concentrating or interested. This allows the system to grasp the state of the child. The AI provides content that matches the guardian's intentions and the child's interests. For example, if the child becomes bored with learning, play content can be provided. This allows the child's interest to be maintained. In addition, the system provides a report of the learning results to the guardian. For example, information such as what content the child was interested in and how much the child was concentrating can be provided as a report. Furthermore, the system aims to generate revenue by proposing teaching materials and services suited to the child's characteristics and the guardian's needs. For example, if the child is interested in a particular field, teaching materials and services related to that field can be proposed. This allows the guardian to select appropriate teaching materials and services to support the child's learning. In this way, the system allows the guardian to input information about the child, monitor the child's state, and provide appropriate content. For example, even if the child becomes bored with learning, interest can be maintained. In addition, the guardian can grasp the child's learning status, and by providing teaching materials and services suited to the child's characteristics and the guardian's needs, the learning effect can be enhanced.

The educational support system according to the embodiment comprises an input unit, a monitoring unit, and a providing unit. The input unit allows the guardian to input information about the child. The information input by the guardian may include, for example, the child's age, interests, and learning goals, but is not limited to such examples. The input unit allows, for example, the guardian to input the child's age. The input unit also allows the guardian to input the child's interests. The input unit also allows the guardian to input the child's learning goals. The monitoring unit monitors the state of the child based on the information input via the input unit. The monitoring unit may, for example, analyze the child's level of concentration and interest using a camera. The monitoring unit may also monitor the child's facial expressions and movements in real time and have the AI analyze them. The monitoring unit may also determine whether the child is concentrating or interested. The providing unit provides content based on the information monitored by the monitoring unit. The providing unit may, for example, provide play content if the child becomes bored with learning. The providing unit may also provide a report of the learning results to the guardian. The providing unit may also propose teaching materials or services suited to the child's characteristics and the guardian's needs. In this way, the educational support system according to the embodiment allows the guardian to input information about the child, monitor the child's state, and provide appropriate content. For example, even if the child becomes bored with learning, interest can be maintained. In addition, the guardian can grasp the child's learning status, and by providing teaching materials and services suited to the child's characteristics and the guardian's needs, the learning effect can be enhanced.

The providing unit can provide play content if the child loses interest in learning. The providing unit may, for example, provide play content if the child is unresponsive for a certain period of time. The providing unit may also provide play content if it determines, based on facial expression analysis results, that the child has lost interest in learning. In addition, the providing unit may provide interactive stories if the child becomes bored with learning. This allows the child's interest to be maintained even if the child becomes bored with learning.

The providing unit can provide a report of the learning results to the guardian. The providing unit may, for example, provide the child's test scores to the guardian as a report. The providing unit may also provide the child's learning time to the guardian as a report. The providing unit may also provide the child's achievement level to the guardian as a report. The report may, for example, be provided in PDF format. The report may also include graphs and charts. This allows the guardian to grasp the child's learning status.

The providing unit can propose teaching materials or services suited to the child's characteristics and the guardian's needs. The providing unit may, for example, propose teaching materials suited to the child's learning style. The providing unit may also propose teaching materials related to fields in which the child is interested. The providing unit may also propose teaching materials suited to the child's learning speed. The providing unit may also propose services suited to the guardian's learning goals. For example, the providing unit can propose individual tutoring services to guardians aiming for the acquisition of specific skills. In this way, by providing teaching materials and services suited to the child's characteristics and the guardian's needs, the learning effect can be enhanced.

The monitoring unit can analyze the child's level of concentration and interest using a camera. The monitoring unit may, for example, track the child's gaze using a camera and analyze the level of concentration. The monitoring unit may also analyze the child's facial expressions using a camera and analyze interest. The monitoring unit may also analyze the child's behavioral patterns using a camera and analyze the level of concentration and interest. In this way, by using a camera, the child's level of concentration and interest can be accurately analyzed.

The input unit allows the guardian to input information such as the child's age, interests, learning goals, and interests. The input unit may, for example, allow the guardian to input the child's age. The input unit may also allow the guardian to input the child's interests. The input unit may also allow the guardian to input the child's learning goals. In this way, by allowing the guardian to input detailed information about the child, more appropriate content can be provided.

The input unit can assist input by referring to past input history in order to improve the accuracy of information input by the guardian. The input unit may, for example, automatically display information about the child previously input by the guardian as candidates. The input unit may also preferentially propose input methods (such as voice or text) previously used by the guardian. The input unit may also predict and propose information to be input at specific times based on the guardian's past input history. In this way, by referring to past input history, the accuracy of input can be improved.

The input unit can increase the types of information that the guardian can input, allowing, for example, input of the child's health status and daily activities. The input unit may, for example, add fields that allow the guardian to input the child's health status (such as body temperature and meal details). The input unit may also provide options that allow the guardian to input the child's daily activities (such as play and learning time). The input unit may also allow the guardian to input specific events (such as school events and sports activities) for the child. In this way, by allowing input of the child's health status and daily activities, more detailed information can be provided.

The input unit can accept information input by the guardian via voice input or image input, thereby diversifying input methods. The input unit may, for example, allow the guardian to input information about the child by voice. The input unit may also allow the guardian to upload images to record the child's health status or activities. The input unit may also allow the guardian to combine voice input and image input to input more detailed information. In this way, by accepting voice input and image input, input methods can be diversified.

The input unit can add a function to share information input by the guardian with other guardians and form a community. The input unit may, for example, provide a function that allows information about the child input by the guardian to be shared with other guardians. The input unit may also provide a forum that allows guardians to exchange opinions based on the information they have input. The input unit may also provide a function that allows guardians to jointly plan events based on the information they have input. In this way, by sharing information with other guardians, a community can be formed and information can be exchanged.

The input unit can add a function to share information input by the guardian with the child's school or educational institution. The input unit may, for example, provide a function that allows information about the child input by the guardian to be shared with the child's teachers at school. The input unit may also provide a function that allows participation in school events and activities based on the information input by the guardian. The input unit may also provide a function that allows the guardian to collaborate with educational institutions to create a learning plan for the child based on the information input. In this way, by sharing information with schools and educational institutions, the child's learning can be supported.

The input unit can add a function to automatically supplement information input by the guardian by comparing it with the child's past learning data. The input unit may, for example, automatically supplement information input by the guardian by comparing it with the child's past learning data. The input unit may also automatically update the child's learning progress based on the information input by the guardian. The input unit may also automatically set the child's learning goals based on the information input by the guardian. In this way, by comparing with past learning data, input information can be automatically supplemented.

The monitoring unit can analyze not only the child's facial expressions but also voice and movements during monitoring to more accurately determine the level of concentration and interest. The monitoring unit may, for example, analyze the child's facial expressions to determine the level of concentration and interest. The monitoring unit may also analyze the child's voice to determine the level of concentration and interest. The monitoring unit may also analyze the child's movements to determine the level of concentration and interest. In this way, by analyzing facial expressions, voice, and movements, the level of concentration and interest can be determined more accurately.

The monitoring unit can refer to the child's past data on concentration and interest during monitoring to predict the current state. The monitoring unit may, for example, refer to the child's past concentration data to predict the current level of concentration. The monitoring unit may also refer to the child's past interest data to predict the current level of interest. The monitoring unit may also refer to the child's past learning data to predict the current learning state. In this way, by referring to past data, the current state can be predicted more accurately.

The monitoring unit can analyze the level of concentration and interest based on the child's environment during monitoring. The monitoring unit may, for example, analyze the child's level of concentration by considering the brightness of the room. The monitoring unit may also analyze the child's level of concentration by considering the room temperature. The monitoring unit may also analyze the child's level of concentration by considering the noise level in the room. In this way, by considering the environment, the level of concentration and interest can be analyzed more accurately.

The monitoring unit can analyze the level of concentration and interest by considering the influence of the child's friends and siblings during monitoring. The monitoring unit may, for example, analyze the level of concentration by considering the presence of the child's friends. The monitoring unit may also analyze the level of concentration by considering the presence of the child's siblings. The monitoring unit may also analyze the level of interest by considering the relationship with the child's friends and siblings. In this way, by considering the influence of friends and siblings, the level of concentration and interest can be analyzed more accurately.

The monitoring unit can adjust the monitoring method according to the type of device used by the child during monitoring. The monitoring unit may, for example, provide a monitoring method optimized for tablets when the child is using a tablet. The monitoring unit may also provide a monitoring method optimized for PCs when the child is using a PC. The monitoring unit may also provide a monitoring method optimized for smartphones when the child is using a smartphone. In this way, by adjusting the monitoring method according to the device used, more appropriate monitoring can be performed.

The monitoring unit can apply different monitoring algorithms according to the learning content of the child during monitoring. The monitoring unit may, for example, apply a monitoring algorithm optimized for mathematics when the child is learning mathematics. The monitoring unit may also apply a monitoring algorithm optimized for English when the child is learning English. The monitoring unit may also apply a monitoring algorithm optimized for science when the child is learning science. In this way, by applying monitoring algorithms according to the learning content, more appropriate monitoring can be performed.

The providing unit can automatically adjust the difficulty of the content to be provided according to the child's learning progress and level of understanding. The providing unit may, for example, adjust the difficulty of the content based on the child's learning progress. The providing unit may also adjust the difficulty of the content based on the child's level of understanding. The providing unit may also adjust the difficulty of the content based on the child's past learning data. In this way, by adjusting the difficulty of the content according to the learning progress and level of understanding, the learning effect for the child can be enhanced.

The providing unit can customize the content to be provided based on the child's interests and concerns. The providing unit may, for example, customize the content based on the child's interests. The providing unit may also customize the content based on the child's concerns. The providing unit may also customize the content based on the child's past learning data. In this way, by customizing the content based on the child's interests and concerns, the learning effect can be enhanced.

The providing unit can optimize the content to be provided by reflecting the child's past learning history. The providing unit may, for example, optimize the content based on the child's past learning history. The providing unit may also optimize the content based on the child's past learning data. The providing unit may also optimize the content based on the child's past learning progress. In this way, by reflecting the past learning history, more appropriate content can be provided.

The providing unit can improve the content to be provided based on feedback from the guardian. The providing unit may, for example, improve the content based on feedback from the guardian. The providing unit may also improve the content by reflecting the guardian's opinions. The providing unit may also adjust the content and format based on the guardian's requests. In this way, by improving the content based on feedback from the guardian, more appropriate content can be provided.

The providing unit can design the content to be provided to promote collaborative learning and competition with other children. The providing unit may, for example, provide content that allows the child to learn collaboratively with other children. The providing unit may also provide game-type content that allows the child to compete with other children. The providing unit may also provide content that allows the child to cooperate with other children to solve problems. In this way, by promoting collaborative learning and competition with other children, the learning effect can be enhanced.

The providing unit can gradually evolve the content to be provided according to the child's learning goals. The providing unit may, for example, gradually increase the difficulty of the content according to the child's learning goals. The providing unit may also gradually evolve the content according to the child's learning progress. The providing unit may also gradually change the format of the content according to the child's level of understanding. In this way, by gradually evolving the content according to the learning goals, the learning effect can be enhanced.

The system according to the embodiment is not limited to the examples described above, and various modifications are possible, for example, as follows.

The providing unit can automatically adjust the difficulty of the learning content according to the child's learning progress. For example, if the child quickly solves a particular problem, the difficulty of the next problem can be increased. If the child is struggling with a particular problem, the providing unit can lower the difficulty of that problem. Furthermore, the providing unit can provide an individually optimized learning plan based on the child's past learning data. In this way, the learning effect for the child can be maximized.

The monitoring unit can monitor the child's learning environment in real time and adjust the learning content according to changes in the environment. For example, if the brightness of the room decreases, the monitoring unit may determine that the child's level of concentration may decrease and provide content that encourages a break. If the room temperature is too high, the monitoring unit may determine that the child's level of concentration may decrease and provide content that encourages cooling. Furthermore, if the noise level in the room is high, the monitoring unit can provide noise-canceling music. In this way, the child's learning environment can be optimized.

The input unit can add a function to share information input by the guardian with other guardians and form a community. For example, the input unit provides a function that allows information about the child input by the guardian to be shared with other guardians. The input unit may also provide a forum that allows guardians to exchange opinions based on the information they have input. Furthermore, the input unit may provide a function that allows guardians to jointly plan events based on the information they have input. In this way, by sharing information with other guardians, a community can be formed and information can be exchanged.

The providing unit can automatically adjust the difficulty of the learning content according to the child's learning progress. For example, if the child quickly solves a particular problem, the difficulty of the next problem can be increased. If the child is struggling with a particular problem, the providing unit can lower the difficulty of that problem. Furthermore, the providing unit can provide an individually optimized learning plan based on the child's past learning data. In this way, the learning effect for the child can be maximized.

The monitoring unit can adjust the monitoring method according to the type of device used by the child. For example, if the child is using a tablet, the monitoring unit provides a monitoring method optimized for tablets. If the child is using a PC, the monitoring unit can also provide a monitoring method optimized for PCs. Furthermore, if the child is using a smartphone, the monitoring unit can also provide a monitoring method optimized for smartphones. In this way, by adjusting the monitoring method according to the device used, more appropriate monitoring can be performed.

The providing unit can design the content to be provided to promote collaborative learning and competition with other children. For example, the providing unit provides content that allows the child to learn collaboratively with other children. The providing unit may also provide game-type content that allows the child to compete with other children. Furthermore, the providing unit may provide content that allows the child to cooperate with other children to solve problems. In this way, by promoting collaborative learning and competition with other children, the learning effect can be enhanced.

The following is a brief explanation of the process flow of Example 1 of the Embodiment.
Step 1: The input unit allows the guardian to input information about the child. The information input by the guardian may include, for example, the child's age, interests, and learning goals. The input unit allows the guardian to input the child's age, interests, and learning goals.
Step 2: The monitoring unit monitors the state of the child based on the information input via the input unit. The monitoring unit can analyze the child's level of concentration and interest using a camera, monitor the child's facial expressions and movements in real time, and have the AI analyze them. It also determines whether the child is concentrating or interested.
Step 3: The providing unit provides content based on the information monitored by the monitoring unit. The providing unit provides play content if the child becomes bored with learning and provides a report of the learning results to the guardian. It also proposes teaching materials and services suited to the child's characteristics and the guardian's needs.

### Example 2 of Embodiment

The system according to the embodiment of the present invention is a system in which a guardian pre-sets information about the child, the content to be provided, and the time, analyzes the child's level of concentration and interest using a camera, and AI provides content that matches the guardian's intentions and the child's interests. The system allows the guardian to pre-set information about the child, the content to be provided, and the time, analyzes the child's level of concentration and interest using a camera, and AI provides content that matches the guardian's intentions and the child's interests. For example, if the child becomes bored with learning, play content can be provided. In addition, the system provides a report of the learning results to the guardian and aims to generate revenue by proposing teaching materials and services suited to the child's characteristics and the guardian's needs. For example, the guardian pre-sets information about the child, the content to be provided, and the time. At this time, information such as the child's age, interests, and learning goals is input. For example, the guardian sets “I want to provide 30 minutes of English learning content to a 5-year-old child.” This information is input to the AI. Next, the child's level of concentration and interest is analyzed using a camera. The camera monitors the child's facial expressions and movements in real time, and the AI analyzes them. For example, it can determine whether the child is concentrating or interested. This allows the system to grasp the state of the child. The AI provides content that matches the guardian's intentions and the child's interests. For example, if the child becomes bored with learning, play content can be provided. This allows the child's interest to be maintained. In addition, the system provides a report of the learning results to the guardian. For example, information such as what content the child was interested in and how much the child was concentrating can be provided as a report. Furthermore, the system aims to generate revenue by proposing teaching materials and services suited to the child's characteristics and the guardian's needs. For example, if the child is interested in a particular field, teaching materials and services related to that field can be proposed. This allows the guardian to select appropriate teaching materials and services to support the child's learning. In this way, the system allows the guardian to input information about the child, monitor the child's state, and provide appropriate content. For example, even if the child becomes bored with learning, interest can be maintained. In addition, the guardian can grasp the child's learning status, and by providing teaching materials and services suited to the child's characteristics and the guardian's needs, the learning effect can be enhanced.

The educational support system according to the embodiment comprises an input unit, a monitoring unit, and a providing unit. The input unit allows the guardian to input information about the child. The information input by the guardian may include, for example, the child's age, interests, and learning goals, but is not limited to such examples. The input unit allows, for example, the guardian to input the child's age. The input unit also allows the guardian to input the child's interests. The input unit also allows the guardian to input the child's learning goals. The monitoring unit monitors the state of the child based on the information input via the input unit. The monitoring unit may, for example, analyze the child's level of concentration and interest using a camera. The monitoring unit may also monitor the child's facial expressions and movements in real time and have the AI analyze them. The monitoring unit may also determine whether the child is concentrating or interested. The providing unit provides content based on the information monitored by the monitoring unit. The providing unit may, for example, provide play content if the child becomes bored with learning. The providing unit may also provide a report of the learning results to the guardian. The providing unit may also propose teaching materials or services suited to the child's characteristics and the guardian's needs. In this way, the educational support system according to the embodiment allows the guardian to input information about the child, monitor the child's state, and provide appropriate content. For example, even if the child becomes bored with learning, interest can be maintained. In addition, the guardian can grasp the child's learning status, and by providing teaching materials and services suited to the child's characteristics and the guardian's needs, the learning effect can be enhanced.

The providing unit can provide play content if the child loses interest in learning. The providing unit may, for example, provide play content if the child is unresponsive for a certain period of time. The providing unit may also provide play content if it determines, based on facial expression analysis results, that the child has lost interest in learning. In addition, the providing unit may provide interactive stories if the child becomes bored with learning. This allows the child's interest to be maintained even if the child becomes bored with learning.

The providing unit can provide a report of the learning results to the guardian. The providing unit may, for example, provide the child's test scores to the guardian as a report. The providing unit may also provide the child's learning time to the guardian as a report. The providing unit may also provide the child's achievement level to the guardian as a report. The report may, for example, be provided in PDF format. The report may also include graphs and charts. This allows the guardian to grasp the child's learning status.

The providing unit can propose teaching materials or services suited to the child's characteristics and the guardian's needs. The providing unit may, for example, propose teaching materials suited to the child's learning style. The providing unit may also propose teaching materials related to fields in which the child is interested. The providing unit may also propose teaching materials suited to the child's learning speed. The providing unit may also propose services suited to the guardian's learning goals. For example, the providing unit can propose individual tutoring services to guardians aiming for the acquisition of specific skills. In this way, by providing teaching materials and services suited to the child's characteristics and the guardian's needs, the learning effect can be enhanced.

The monitoring unit can analyze the child's level of concentration and interest using a camera. The monitoring unit may, for example, track the child's gaze using a camera and analyze the level of concentration. The monitoring unit may also analyze the child's facial expressions using a camera and analyze interest. The monitoring unit may also analyze the child's behavioral patterns using a camera and analyze the level of concentration and interest. In this way, by using a camera, the child's level of concentration and interest can be accurately analyzed.

The input unit allows the guardian to input information such as the child's age, interests, learning goals, and interests. The input unit may, for example, allow the guardian to input the child's age. The input unit may also allow the guardian to input the child's interests. The input unit may also allow the guardian to input the child's learning goals. In this way, by allowing the guardian to input detailed information about the child, more appropriate content can be provided.

The input unit can estimate the guardian's emotions and adjust the display method of the input interface based on the estimated emotions of the guardian. The input unit may, for example, provide a simple interface and minimize input steps if the guardian is feeling stressed. The input unit may also provide detailed input options and propose customizable input methods if the guardian is relaxed. The input unit may also prioritize voice input and allow quick input of the child's information if the guardian is in a hurry. In this way, by adjusting the input interface according to the guardian's emotions, input stress can be reduced. Emotion estimation is realized, for example, by using an emotion estimation function with an emotion engine or generative AI. The generative AI may be a text generation AI (for example, LLM) or a multimodal generative AI, but is not limited to such examples.

The input unit can assist input by referring to past input history in order to improve the accuracy of information input by the guardian. The input unit may, for example, automatically display information about the child previously input by the guardian as candidates. The input unit may also preferentially propose input methods (such as voice or text) previously used by the guardian. The input unit may also predict and propose information to be input at specific times based on the guardian's past input history. In this way, by referring to past input history, the accuracy of input can be improved.

The input unit can increase the types of information that the guardian can input, allowing, for example, input of the child's health status and daily activities. The input unit may, for example, add fields that allow the guardian to input the child's health status (such as body temperature and meal details). The input unit may also provide options that allow the guardian to input the child's daily activities (such as play and learning time). The input unit may also allow the guardian to input specific events (such as school events and sports activities) for the child. In this way, by allowing input of the child's health status and daily activities, more detailed information can be provided.

The input unit can accept information input by the guardian via voice input or image input, thereby diversifying input methods. The input unit may, for example, allow the guardian to input information about the child by voice. The input unit may also allow the guardian to upload images to record the child's health status or activities. The input unit may also allow the guardian to combine voice input and image input to input more detailed information. In this way, by accepting voice input and image input, input methods can be diversified.

The input unit can estimate the guardian's emotions and determine the priority of input items based on the estimated emotions of the guardian. The input unit may, for example, prioritize the input of only important information if the guardian is feeling stressed. The input unit may also provide options for inputting detailed information if the guardian is relaxed. The input unit may also have the guardian input the most important information first if the guardian is in a hurry. In this way, by determining the priority of input items according to the guardian's emotions, input efficiency can be improved. Emotion estimation is realized, for example, by using an emotion estimation function with an emotion engine or generative AI. The generative AI may be a text generation AI (for example, LLM) or a multimodal generative AI, but is not limited to such examples.

The input unit can add a function to share information input by the guardian with other guardians and form a community. The input unit may, for example, provide a function that allows information about the child input by the guardian to be shared with other guardians. The input unit may also provide a forum that allows guardians to exchange opinions based on the information they have input. The input unit may also provide a function that allows guardians to jointly plan events based on the information they have input. In this way, by sharing information with other guardians, a community can be formed and information can be exchanged.

The input unit can add a function to share information input by the guardian with the child's school or educational institution. The input unit may, for example, provide a function that allows information about the child input by the guardian to be shared with the child's teachers at school. The input unit may also provide a function that allows participation in school events and activities based on the information input by the guardian. The input unit may also provide a function that allows the guardian to collaborate with educational institutions to create a learning plan for the child based on the information input. In this way, by sharing information with schools and educational institutions, the child's learning can be supported.

The input unit can add a function to automatically supplement information input by the guardian by comparing it with the child's past learning data. The input unit may, for example, automatically supplement information input by the guardian by comparing it with the child's past learning data. The input unit may also automatically update the child's learning progress based on the information input by the guardian. The input unit may also automatically set the child's learning goals based on the information input by the guardian. In this way, by comparing with past learning data, input information can be automatically supplemented.

The monitoring unit can estimate the child's emotions and adjust the frequency and method of monitoring based on the estimated emotions of the child. The monitoring unit may, for example, reduce the frequency of monitoring and allow the child to concentrate on learning if the child is concentrating. The monitoring unit may also increase the frequency of monitoring and provide appropriate content if the child is excited. The monitoring unit may also reduce the frequency of monitoring and encourage breaks if the child is tired. In this way, by adjusting the frequency and method of monitoring according to the child's emotions, more appropriate monitoring can be performed. Emotion estimation is realized, for example, by using an emotion estimation function with an emotion engine or generative AI. The generative AI may be a text generation AI (for example, LLM) or a multimodal generative AI, but is not limited to such examples.

The monitoring unit can analyze not only the child's facial expressions but also voice and movements during monitoring to more accurately determine the level of concentration and interest. The monitoring unit may, for example, analyze the child's facial expressions to determine the level of concentration and interest. The monitoring unit may also analyze the child's voice to determine the level of concentration and interest. The monitoring unit may also analyze the child's movements to determine the level of concentration and interest. In this way, by analyzing facial expressions, voice, and movements, the level of concentration and interest can be determined more accurately.

The monitoring unit can refer to the child's past data on concentration and interest during monitoring to predict the current state. The monitoring unit may, for example, refer to the child's past concentration data to predict the current level of concentration. The monitoring unit may also refer to the child's past interest data to predict the current level of interest. The monitoring unit may also refer to the child's past learning data to predict the current learning state. In this way, by referring to past data, the current state can be predicted more accurately.

The monitoring unit can analyze the level of concentration and interest based on the child's environment during monitoring. The monitoring unit may, for example, analyze the child's level of concentration by considering the brightness of the room. The monitoring unit may also analyze the child's level of concentration by considering the room temperature. The monitoring unit may also analyze the child's level of concentration by considering the noise level in the room. In this way, by considering the environment, the level of concentration and interest can be analyzed more accurately.

The monitoring unit can estimate the child's emotions and adjust the display method of monitoring results based on the estimated emotions of the child. The monitoring unit may, for example, provide a simple display method if the child is concentrating. The monitoring unit may also provide a detailed display method if the child is excited. The monitoring unit may also provide a highly visible display method if the child is tired. In this way, by adjusting the display method of monitoring results according to the child's emotions, visibility can be improved. Emotion estimation is realized, for example, by using an emotion estimation function with an emotion engine or generative AI. The generative AI may be a text generation AI (for example, LLM) or a multimodal generative AI, but is not limited to such examples.

The monitoring unit can analyze the level of concentration and interest by considering the influence of the child's friends and siblings during monitoring. The monitoring unit may, for example, analyze the level of concentration by considering the presence of the child's friends. The monitoring unit may also analyze the level of concentration by considering the presence of the child's siblings. The monitoring unit may also analyze the level of interest by considering the relationship with the child's friends and siblings. In this way, by considering the influence of friends and siblings, the level of concentration and interest can be analyzed more accurately.

The monitoring unit can adjust the monitoring method according to the type of device used by the child during monitoring. The monitoring unit may, for example, provide a monitoring method optimized for tablets when the child is using a tablet. The monitoring unit may also provide a monitoring method optimized for PCs when the child is using a PC. The monitoring unit may also provide a monitoring method optimized for smartphones when the child is using a smartphone. In this way, by adjusting the monitoring method according to the device used, more appropriate monitoring can be performed.

The monitoring unit can apply different monitoring algorithms according to the learning content of the child during monitoring. The monitoring unit may, for example, apply a monitoring algorithm optimized for mathematics when the child is learning mathematics. The monitoring unit may also apply a monitoring algorithm optimized for English when the child is learning English. The monitoring unit may also apply a monitoring algorithm optimized for science when the child is learning science. In this way, by applying monitoring algorithms according to the learning content, more appropriate monitoring can be performed.

The providing unit can estimate the child's emotions and adjust the type and timing of content to be provided based on the estimated emotions of the child. The providing unit may, for example, provide learning content if the child is concentrating. The providing unit may also provide play content if the child is excited. The providing unit may also provide relaxing content if the child is tired. In this way, by adjusting the type and timing of content according to the child's emotions, more appropriate content can be provided. Emotion estimation is realized, for example, by using an emotion estimation function with an emotion engine or generative AI. The generative AI may be a text generation AI (for example, LLM) or a multimodal generative AI, but is not limited to such examples.

The providing unit can automatically adjust the difficulty of the content to be provided according to the child's learning progress and level of understanding. The providing unit may, for example, adjust the difficulty of the content based on the child's learning progress. The providing unit may also adjust the difficulty of the content based on the child's level of understanding. The providing unit may also adjust the difficulty of the content based on the child's past learning data. In this way, by adjusting the difficulty of the content according to the learning progress and level of understanding, the learning effect for the child can be enhanced.

The providing unit can customize the content to be provided based on the child's interests and concerns. The providing unit may, for example, customize the content based on the child's interests. The providing unit may also customize the content based on the child's concerns. The providing unit may also customize the content based on the child's past learning data. In this way, by customizing the content based on the child's interests and concerns, the learning effect can be enhanced.

The providing unit can optimize the content to be provided by reflecting the child's past learning history. The providing unit may, for example, optimize the content based on the child's past learning history. The providing unit may also optimize the content based on the child's past learning data. The providing unit may also optimize the content based on the child's past learning progress. In this way, by reflecting the past learning history, more appropriate content can be provided.

The providing unit can estimate the child's emotions and adjust the display method of content to be provided based on the estimated emotions of the child. The providing unit may, for example, provide a simple display method if the child is concentrating. The providing unit may also provide a detailed display method if the child is excited. The providing unit may also provide a highly visible display method if the child is tired. In this way, by adjusting the display method of content according to the child's emotions, visibility can be improved. Emotion estimation is realized, for example, by using an emotion estimation function with an emotion engine or generative AI. The generative AI may be a text generation AI (for example, LLM) or a multimodal generative AI, but is not limited to such examples.

The providing unit can improve the content to be provided based on feedback from the guardian. The providing unit may, for example, improve the content based on feedback from the guardian. The providing unit may also improve the content by reflecting the guardian's opinions. The providing unit may also adjust the content and format based on the guardian's requests. In this way, by improving the content based on feedback from the guardian, more appropriate content can be provided.

The providing unit can design the content to be provided to promote collaborative learning and competition with other children. The providing unit may, for example, provide content that allows the child to learn collaboratively with other children. The providing unit may also provide game-type content that allows the child to compete with other children. The providing unit may also provide content that allows the child to cooperate with other children to solve problems. In this way, by promoting collaborative learning and competition with other children, the learning effect can be enhanced. The providing unit can gradually evolve the content to be provided according to the child's learning goals. The providing unit may, for example, gradually increase the difficulty of the content according to the child's learning goals. The providing unit may also gradually evolve the content according to the child's learning progress. The providing unit may also gradually change the format of the content according to the child's level of understanding. In this way, by gradually evolving the content according to the learning goals, the learning effect can be enhanced.

### ===Hardware Guarantee 1-1===

Each of the plurality of elements including the input unit, monitoring unit, and providing unit described above is realized by at least one of, for example, the smart device 14 and the data processing device 12. For example, the input unit is realized by the control unit 46A of the smart device 14, and the guardian can input information about the child. The monitoring unit analyzes the child's level of concentration and interest using the camera 42 of the smart device 14 and is analyzed by the specific processing unit 290 of the data processing device 12. The providing unit is realized by the specific processing unit 290 of the data processing device 12 and provides content that matches the guardian's intentions and the child's interests.

### ===Hardware Guarantee 1-2===

Each of the plurality of elements including the input unit, monitoring unit, and providing unit described above is realized by at least one of, for example, the smart glasses 214 and the data processing device 12. For example, the input unit is realized by the control unit 46A of the smart glasses 214, and the guardian can input information about the child. The monitoring unit analyzes the child's level of concentration and interest using the camera 42 of the smart glasses 214 and is analyzed by the specific processing unit 290 of the data processing device 12. The providing unit is realized by the specific processing unit 290 of the data processing device 12 and provides content that matches the guardian's intentions and the child's interests.

### ===Hardware Guarantee 1-3===

Each of the plurality of elements including the input unit, monitoring unit, and providing unit described above is realized by at least one of, for example, the headset-type terminal 314 and the data processing device 12. For example, the input unit is realized by the control unit 46A of the headset-type terminal 314, and the guardian can input information about the child. The monitoring unit analyzes the child's level of concentration and interest using the camera 42 of the headset-type terminal 314 and is analyzed by the specific processing unit 290 of the data processing device 12. The providing unit is realized by the specific processing unit 290 of the data processing device 12 and provides content that matches the guardian's intentions and the child's interests.

### ===Hardware Guarantee 1-4===

Each of the plurality of elements including the input unit, monitoring unit, and providing unit described above is realized by at least one of, for example, the robot 414 and the data processing device 12. For example, the input unit is realized by the control unit 46A of the robot 414, and the guardian can input information about the child. The monitoring unit analyzes the child's level of concentration and interest using the camera 42 of the robot 414 and is analyzed by the specific processing unit 290 of the data processing device 12. The providing unit is realized by the specific processing unit 290 of the data processing device 12 and provides content that matches the guardian's intentions and the child's interests.

The system according to the embodiment is not limited to the examples described above, and various modifications are possible, for example, as follows.

The providing unit can automatically adjust the difficulty of the learning content according to the child's learning progress. For example, if the child quickly solves a particular problem, the difficulty of the next problem can be increased. If the child is struggling with a particular problem, the providing unit can lower the difficulty of that problem. Furthermore, the providing unit can provide an individually optimized learning plan based on the child's past learning data. In this way, the learning effect for the child can be maximized.

The monitoring unit can monitor the child's learning environment in real time and adjust the learning content according to changes in the environment. For example, if the brightness of the room decreases, the monitoring unit may determine that the child's level of concentration may decrease and provide content that encourages a break. If the room temperature is too high, the monitoring unit may determine that the child's level of concentration may decrease and provide content that encourages cooling. Furthermore, if the noise level in the room is high, the monitoring unit can provide noise-canceling music. In this way, the child's learning environment can be optimized.

The providing unit can estimate the child's emotions and adjust the format of the learning content based on the estimated emotions. For example, if the child is feeling stressed, the providing unit can provide relaxing content. If the child is excited, the providing unit can also provide content to improve concentration. Furthermore, if the child is tired, the providing unit can provide content that encourages breaks. In this way, by adjusting the format of the learning content according to the child's emotions, the learning effect can be enhanced.

The input unit can add a function to share information input by the guardian with other guardians and form a community. For example, the input unit provides a function that allows information about the child input by the guardian to be shared with other guardians. The input unit may also provide a forum that allows guardians to exchange opinions based on the information they have input. Furthermore, the input unit may provide a function that allows guardians to jointly plan events based on the information they have input. In this way, by sharing information with other guardians, a community can be formed and information can be exchanged.

The monitoring unit can estimate the child's emotions and adjust the frequency and method of monitoring based on the estimated emotions. For example, if the child is concentrating, the monitoring unit reduces the frequency of monitoring and allows the child to concentrate on learning. If the child is excited, the monitoring unit can increase the frequency of monitoring and provide appropriate content. Furthermore, if the child is tired, the monitoring unit can reduce the frequency of monitoring and encourage breaks. In this way, by adjusting the frequency and method of monitoring according to the child's emotions, more appropriate monitoring can be performed.

The providing unit can automatically adjust the difficulty of the learning content according to the child's learning progress. For example, if the child quickly solves a particular problem, the difficulty of the next problem can be increased. If the child is struggling with a particular problem, the providing unit can lower the difficulty of that problem. Furthermore, the providing unit can provide an individually optimized learning plan based on the child's past learning data. In this way, the learning effect for the child can be maximized.

The input unit can estimate the guardian's emotions and adjust the display method of the input interface based on the estimated emotions. For example, if the guardian is feeling stressed, the input unit provides a simple interface and minimizes input steps. If the guardian is relaxed, the input unit can also provide detailed input options and propose customizable input methods. Furthermore, if the guardian is in a hurry, the input unit can prioritize voice input and allow quick input of the child's information. In this way, by adjusting the input interface according to the guardian's emotions, input stress can be reduced.

The providing unit can estimate the child's emotions and adjust the type and timing of content to be provided based on the estimated emotions. For example, if the child is concentrating, the providing unit provides learning content. If the child is excited, the providing unit can also provide play content. Furthermore, if the child is tired, the providing unit can provide relaxing content. In this way, by adjusting the type and timing of content according to the child's emotions, more appropriate content can be provided.

The monitoring unit can adjust the monitoring method according to the type of device used by the child. For example, if the child is using a tablet, the monitoring unit provides a monitoring method optimized for tablets. If the child is using a PC, the monitoring unit can also provide a monitoring method optimized for PCs. Furthermore, if the child is using a smartphone, the monitoring unit can also provide a monitoring method optimized for smartphones. In this way, by adjusting the monitoring method according to the device used, more appropriate monitoring can be performed.

The providing unit can design the content to be provided to promote collaborative learning and competition with other children. For example, the providing unit provides content that allows the child to learn collaboratively with other children. The providing unit may also provide game-type content that allows the child to compete with other children. Furthermore, the providing unit may provide content that allows the child to cooperate with other children to solve problems. In this way, by promoting collaborative learning and competition with other children, the learning effect can be enhanced.

The following is a brief explanation of the process flow of Example 2 of the Embodiment.
Step 1: The input unit allows the guardian to input information about the child. The information input by the guardian may include, for example, the child's age, interests, and learning goals. The input unit allows the guardian to input the child's age, interests, and learning goals.
Step 2: The monitoring unit monitors the state of the child based on the information input via the input unit. The monitoring unit can analyze the child's level of concentration and interest using a camera, monitor the child's facial expressions and movements in real time, and have the AI analyze them. It also determines whether the child is concentrating or interested.
Step 3: The providing unit provides content based on the information monitored by the monitoring unit. The providing unit provides play content if the child becomes bored with learning and provides a report of the learning results to the guardian. It also proposes teaching materials and services suited to the child's characteristics and the guardian's needs.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

The correspondence between each unit and the devices or control units is not limited to the examples described above, and various modifications are possible.

### Second Embodiment

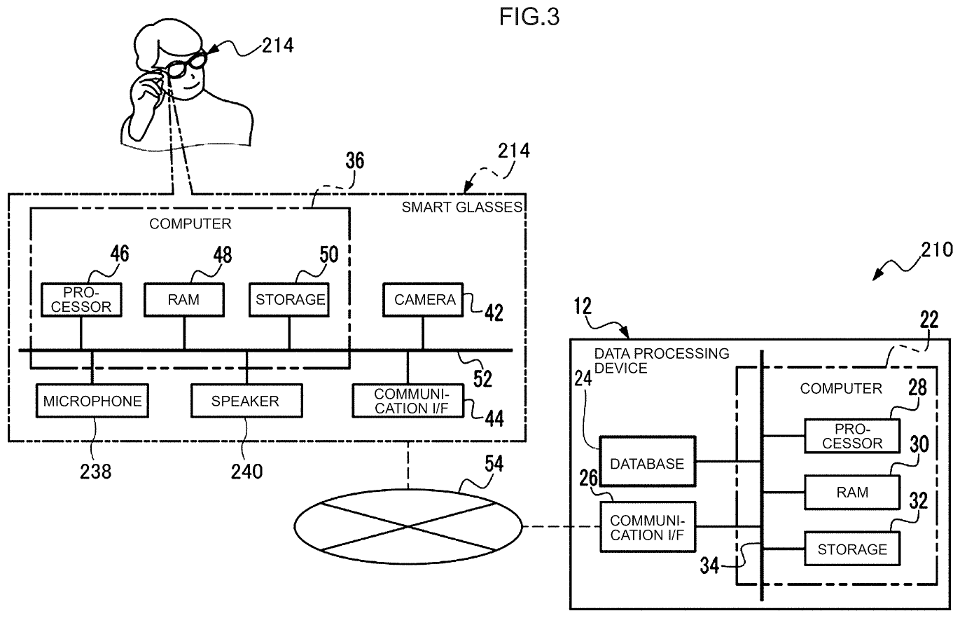

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

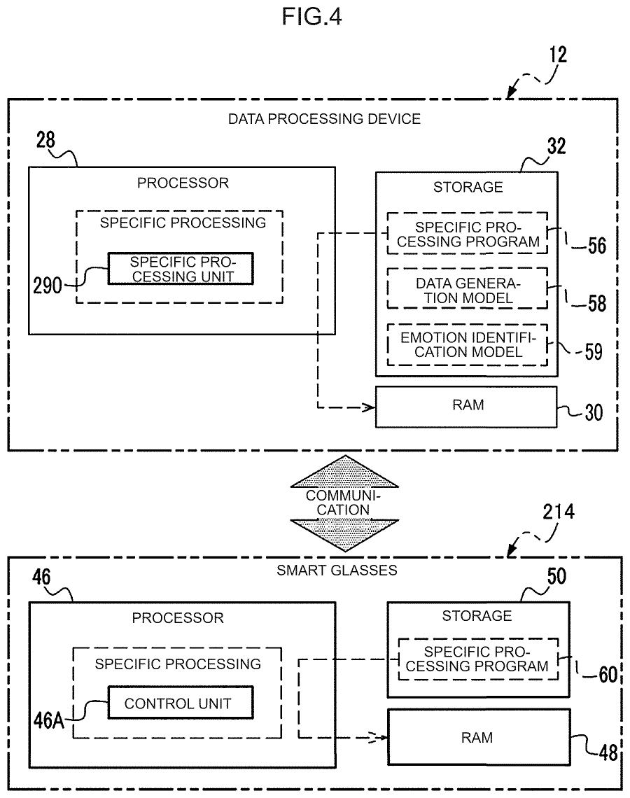

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

The correspondence between each unit and the devices or control units is not limited to the examples described above, and various modifications are possible.

### Third Embodiment

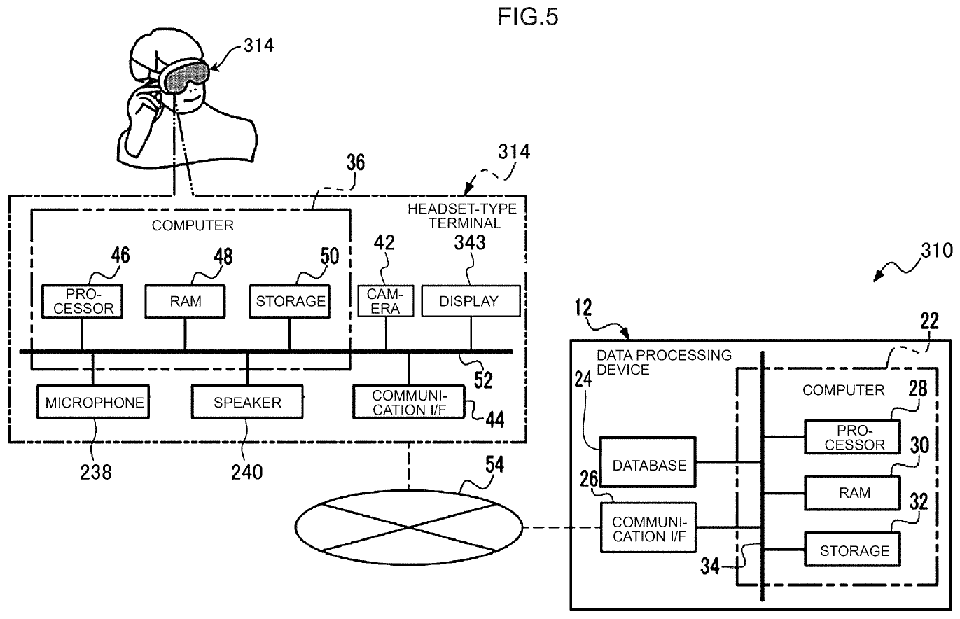

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

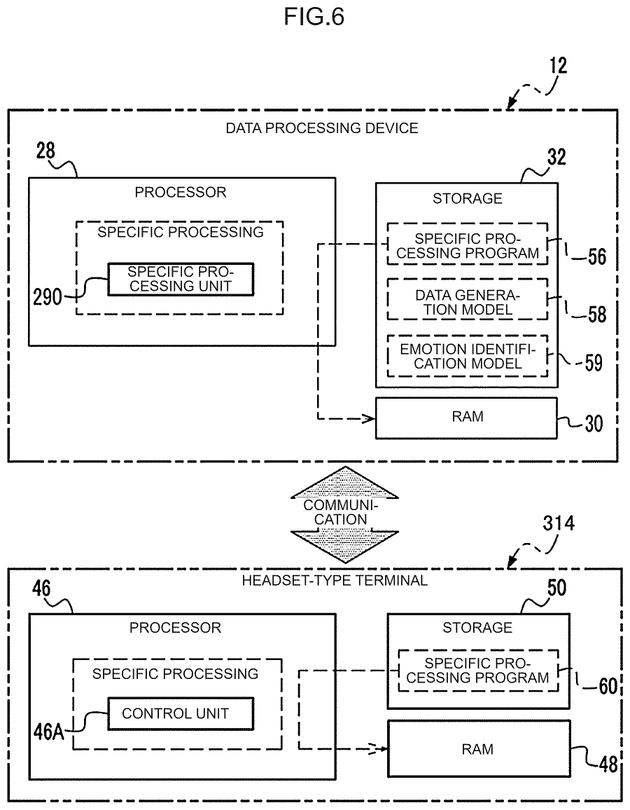

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example,

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

The correspondence between each unit and the devices or control units is not limited to the examples described above, and various modifications are possible.

### Fourth Embodiment

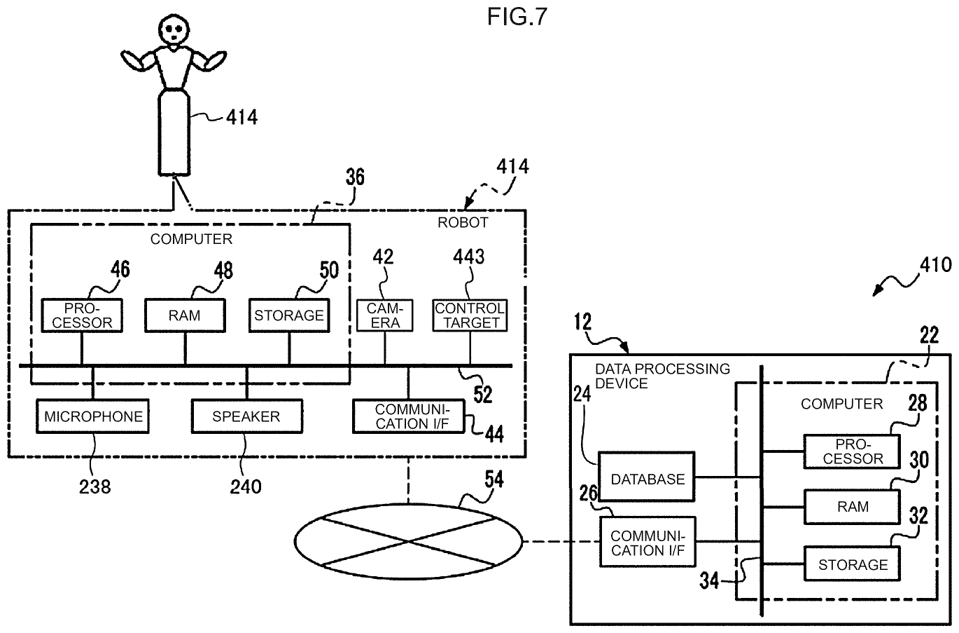

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

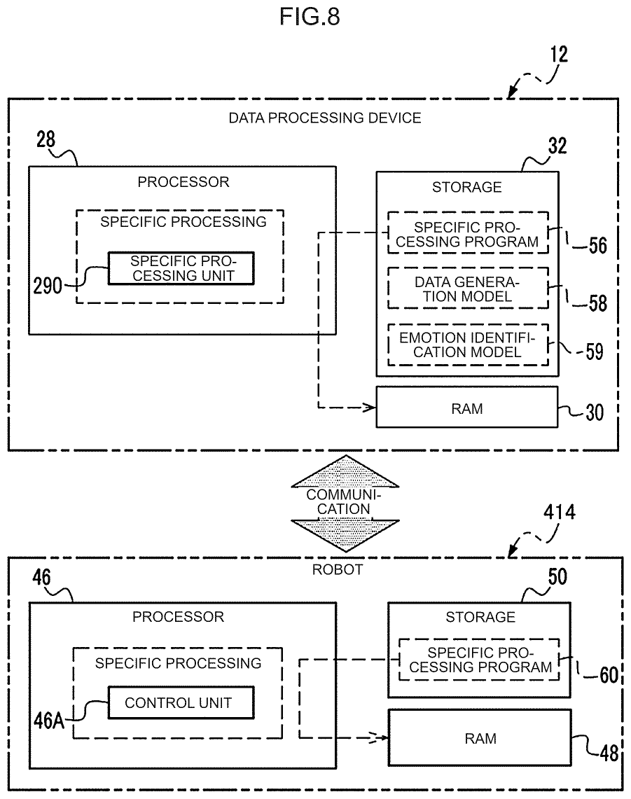

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example,

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

The correspondence between each unit and the devices or control units is not limited to the examples described above, and various modifications are possible.

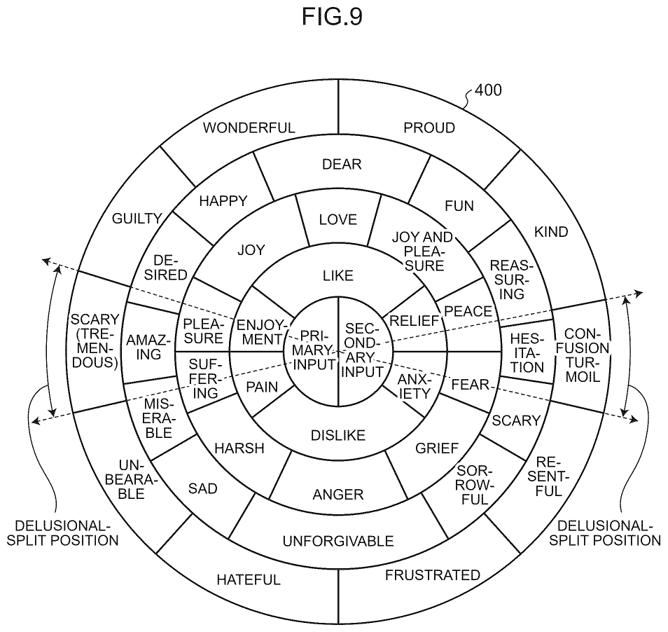

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

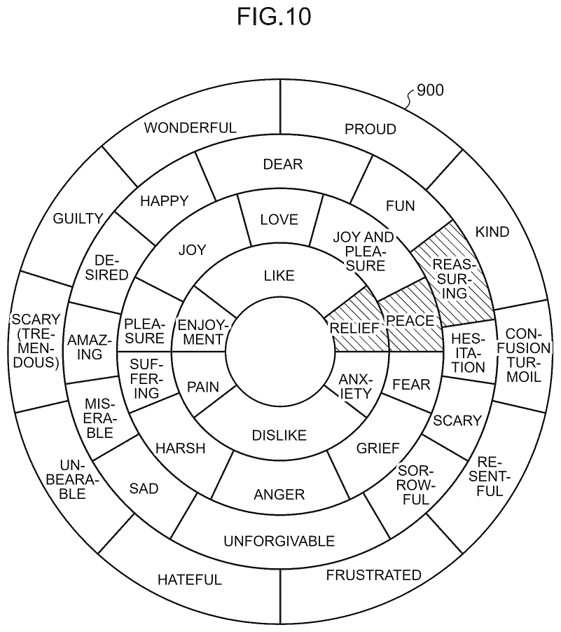

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above.

Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

What is claimed is:

1. A system comprising: an input unit through which a guardian inputs information about a child; a monitoring unit that monitors the state of the child based on the information input via the input unit; and a providing unit that provides content based on the information monitored by the monitoring unit.

2. The system according to claim 1, wherein the providing unit provides play content when the child loses interest in learning.

3. The system according to claim 1, wherein the providing unit provides a report of the learning results to the guardian.

4. The system according to claim 1, wherein the providing unit proposes teaching materials or services suited to the characteristics of the child and the needs of the guardian.

5. The system according to claim 1, wherein the monitoring unit analyzes the child's level of concentration and interest using a camera.

6. The system according to claim 1, wherein the input unit allows the guardian to input information such as the child's age, interests, learning goals, and interests.

7. The system according to claim 1, wherein the input unit estimates the guardian's emotions and adjusts the display method of the input interface based on the estimated emotions of the guardian.

8. The system according to claim 1, wherein the input unit assists input by referring to past input history in order to improve the accuracy of information input by the guardian.

9. The system according to claim 1, wherein the input unit increases the types of information that the guardian can input, allowing, for example, input of the child's health status and daily activities.

10. The system according to claim 1, wherein the input unit accepts information input by the guardian via voice input or image input, thereby diversifying input methods.
